(19) United States
(12) Patent Application Publication
(10) Pub. No.: US 2017/0288494 A1
(43) Pub. Date: Oct. 5, 2017

(54) SPINDLE MOTOR

(71) Applicant: MINEBEA MITSUMI INC., Kitasaku-gun (JP)

(72) Inventors: Hideaki SHOWA, Kitasaku-gun (JP); Daigo NAKAJIMA, Tomi-shi (JP); Naoyuki KONDO, VS-Weigheim (DE)

(73) Assignee: MINEBEA MITSUMI INC., Kitasaku-gun (JP)

(21) Appl. No.: 15/472,385

(22) Filed: Mar. 29, 2017

(30) Foreign Application Priority Data
Mar. 31, 2016 (JP) 2016-071412

(51) Int. Cl. H02K 5/22; G11B 19/20; H02K 1/27

(52) U.S. Cl. CPC H02K 5/22; H02K 1/2786; G11B 19/2036; H02K 2213/03

(57) ABSTRACT

A spindle motor has a base plate, a stator core fixed to the base plate, a rotor member rotatable with respect to the base plate, a rotor magnet facing the stator core in a radial direction and fixed to the rotor member and a ring-shaped magnetic attractive plate attached to the base plate bottom surface facing the rotor magnet in an axial direction to generate a magnetic attracting force between the rotor magnet and the magnetic attractive plate. A ring-shaped wall surface is on the base plate bottom surface. At least one of an outer and inner circumference of the ring-shaped magnetic attractive plate has a polygonal shape formed of linear parts and corner parts. In a state in which at least one of the outer and inner circumferences having the polygonal shape contacts the ring-shaped wall surface, the ring-shaped magnetic attractive plate is adhesively fixed to the base plate.

### CROSS REFERENCE TO RELATED APPLICATIONS

This application claims the benefit of Japanese Patent Application No. 2016-071412, filed on Mar. 31, 2016, which is hereby incorporated by reference in its entirety.

### BACKGROUND

### Technical Field

The present disclosure relates to a spindle motor featuring a structure for fixing a magnetic attractive plate.

### Background

A magnetic disk of a hard disk drive (HDD) is driven by a spindle motor. To suppress vertical motion in an axial direction of a hub on which the magnetic disk is mounted, this spindle motor may be provided with a ring-shaped magnetic attractive plate disposed on a part of a base plate facing a rotor magnet disposed on the hub in the axial direction. By generating a magnetic attractive force between the magnetic attractive plate and the rotor magnet, it is possible to suppress the fluctuation of the hub in the axial direction during motor rotation.

Regarding a structure in which the magnetic attractive plate is fixed to the base plate, Japanese Patent Application Laid-Open No. 2011-239587 describes a structure in which a plurality of protrusions are provided on an inner circumference of the ring-shaped magnetic attractive plate, and Japanese Patent Application Laid-Open No. 2007-43893 describes a structure in which a plurality of protrusions are provided, by contrast, on an outer circumference.

Examples of the method of fixing the magnetic attractive plate to the base plate include a method using press fitting and a method using an adhesive. The magnetic attractive plates described in Japanese Patent Application Laid-Open No. 2011-239587 and Japanese Patent Application Laid-Open No. 2007-43893 include a ring-shaped part and protruding parts that extend from the ring-shaped part in a radial direction and are arranged to be fixed by press fitting, but may require high machining cost. That is, the magnetic attractive plate is manufactured by punching a sheet material of a magnetic material such as an electromagnetic steel sheet through press work, and further, machining for deburring. However, the shapes described in Japanese Patent Application Laid-Open No. 2011-239587 and Japanese Patent Application Laid-Open No. 2007-43893 are not easy to perform deburring on a joint between the ring-shaped part and each of the protruding parts, consequently leading to a cost increase.

On the other hand, with the method using adhesion, the position of the magnetic attractive plate may be shifted due to expansion and contraction of the adhesive at a stage at which the adhesive hardens. It may happens that the magnetic attractive plate is shifted from the installation position due to handling before the adhesive hardens or the magnetic attractive plate comes off from the base plate. A solution to this is a method of holding the magnetic attractive plate using a jig until the adhesive becomes solid, but this method increases man-hours, resulting in an increase of manufacturing cost.

### SUMMARY

Considering such a background, the present disclosure is related to a structure having a magnetic attractive plate fixed to a base plate of a spindle motor by an adhesive in which the magnetic attractive plate is positioned with high stability and the manufacturing cost is reduced.

In accordance with the present disclosure, a spindle motor includes a base plate, a stator core fixed to the base plate, a rotor member rotatable with respect to the base plate, a rotor magnet facing the stator core in a radial direction and fixed to the rotor member, and a ring-shaped magnetic attractive plate attached to a bottom surface of the base plate in a manner to face the rotor magnet in an axial direction and configured to generate a magnetic attracting force between the rotor magnet and the magnetic attractive plate. A ring-shaped wall surface is provided on the bottom surface of the base plate. At least one of an outer circumference and an inner circumference of the ring-shaped magnetic attractive plate has a polygonal shape formed of a plurality of linear parts and a plurality of corner parts. The ring-shaped magnetic attractive plate is fixed to the base plate with an adhesive in a condition that at least one of the outer circumference and the inner circumference having the polygonal shape is in contact with the ring-shaped wall surface.

In accordance with an aspect of the present disclosure, the number of corner parts in the polygonal shape of the magnetic attractive plate may be a prime number. The above-described prime number may be any one of 7, 11, 13, 17 and 19.

In accordance with an aspect of the present disclosure, a portion of the magnetic attraction plate where at least one of the outer circumference and the inner circumference having the polygonal shape is in contact with the ring-shaped wall surface is fitted by an interference fit or transition fit.

In accordance with an aspect of the present disclosure, a structure is provided in which the outer circumference or the inner circumference of the magnetic attractive plate is circular. In accordance with an aspect of the present disclosure, a structure is provided in which the same number of corner parts are formed on the inner circumference and the outer circumference of the magnetic attractive plate.

In accordance with an aspect of the present disclosure, a structure is provided in which the outer circumference and the inner circumference of the magnetic attractive plate include roll-over portions on the same side in the axial direction and the magnetic attractive plate is fixed with the side with roll-over portions facing the bottom surface of the base plate.

In accordance with an aspect of the present disclosure, a structure is provided in which the outer circumference of the magnetic attractive plate having the polygonal shape when viewed from the axial direction is located outside the outer diameter of the rotor magnet in the radial direction.

In accordance with an aspect of the present disclosure, a structure is provided in which the inner circumference of the magnetic attractive plate having the polygonal shape when viewed from the axial direction is located inside the inner diameter of the rotor magnet in the radial direction.

The present disclosure provides a technique for a structure for fixing a magnetic attractive plate to a stator of a spindle motor using an adhesive, providing high positional stability of the magnetic attractive plate and capable of reducing manufacturing cost.

### BRIEF DESCRIPTION OF THE DRAWINGS

FIG. 1A and FIG. 1B are lateral cross-sectional views according to an embodiment;

FIG. 2 is a top view of the embodiment;

FIG. 3A and FIG. 3B are a top view and a lateral cross-sectional view of a magnetic attractive plate, respectively, and FIG. 3C is a top view illustrating a positional relationship between the magnetic attractive plate and a rotor magnet;

FIG. 4 is an enlarged cross-sectional view showing a partially enlarged view of FIG. 1;

FIG. 5 is a top view of a magnetic attractive plate;

FIG. 6 is a top view of a magnetic attractive plate;

FIG. 7 is a top view of an embodiment;

FIG. 8 is a top view of a magnetic attractive plate;

FIGS. 9A and 9B are enlarged cross-sectional views of an embodiment; and

FIGS. 10A and 10B are enlarged cross-sectional views of an embodiment.

### DETAILED DESCRIPTION

### 1. First Embodiment

### (Configuration)

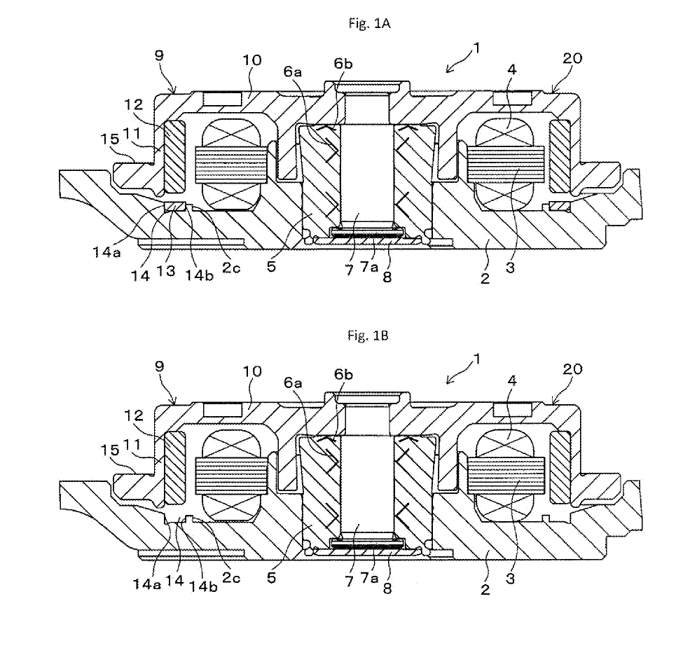

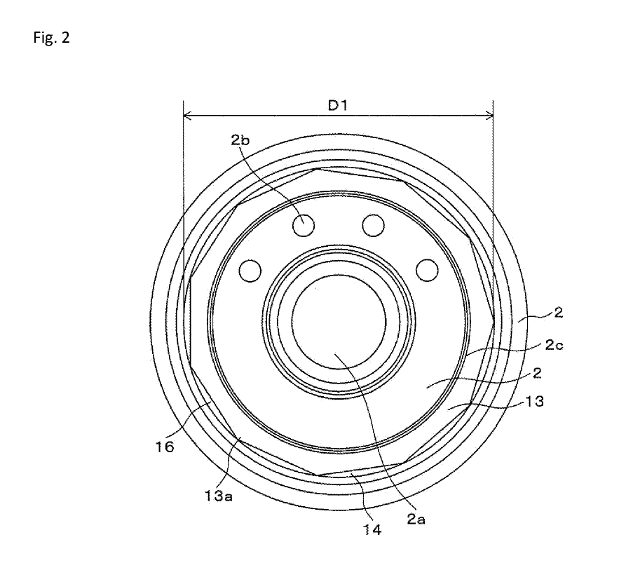

FIGS. 1A and 1B illustrate a spindle motor 1. FIG. 1B shows a state in which a ring-shaped magnetic attractive plate 13 in FIG. 1A is removed. FIG. 2 shows a top view of a state in which a rotation part (rotor) and a stator core 3 described later are removed from the spindle motor 1 and viewed from an axial direction. The spindle motor 1 is provided with a base plate 2 which corresponds to a stationary part. The base plate 2 is formed of, for example, an aluminum alloy and a stator core 3 is fixed thereto. The stator core 3 has a structure in which electromagnetic steel sheets which are processed into an annular shape are laminated together in the axial direction. The stator core 3 includes a plurality of pole teeth (salient poles) extending in a direction away from the axis center and disposed along the circumferential direction. Each pole tooth is wound with a coil winding 4 which becomes a drive coil.

A hole 2a (see FIG. 2) that penetrates in the axial direction and holes 2b (see FIG. 2) to lead out a lead wire from the coil winding 4 to a rear surface (undersurface in FIG. 1) side of the base plate 2 are provided at the base plate 2. A substantially cylindrical bearing part 5 is fixed to the hole 2a. Minute gaps are provided between an inner surface of the bearing part 5 and a shaft 7 and between a top end face of the bearing part 5 and a hub surface (undersurface of a hub 9), and these gaps are filled with a lubricant. A dynamic pressure groove 6a and a dynamic pressure groove 6b are provided in an inner surface of the bearing part 5 and a top end face of the bearing part 5 respectively to cause a rotor 20 including the shaft 7 and the hub 9 to rotate with respect to the bearing part 5 in a non-contact manner.

The rotor 20 is rotatably held by the bearing part 5. The rotor 20 includes a rotor magnet 12, the hub 9 and the shaft 7. The rotor 20 rotates with respect to the bearing part 5 which is fixed to the base plate 2. A through hole is provided at the center of the bearing part 5 in the axial direction and the shaft 7 is rotatably held therein. The through hole is closed by a counter plate 8 on the bottom end side of the bearing part 5. A flange part 7a is provided at an end of the shaft 7 on the bottom end side to stop the shaft 7 from coming off the bearing part 5. The hub 9 which is the rotor member is fixed to the top end part of the shaft 7. The hub 9 includes a disk part 10 and a cylindrical part 11 that extends from the outer edge of the disk part downward in the axial direction. The hub 9 further includes a mount part 15 that extends from the bottom lower end part of the cylindrical part 11 to the outside in the radial direction. Though not shown in FIGS. 1A and 1B, a magnetic disk of a hard disk drive is fixed to the top surface of the mount part 15.

The hub 9 is made of a magnetic material and the cylindrical part 11 also functions as a back yoke that suppresses leakage of a magnetic flux from the rotor magnet 12. Here, to suppress leakage of the magnetic flux from the end face of the rotor magnet 12, the bottom end part of the cylindrical part 11 protrudes from the bottom end face of the rotor magnet 12 in the axial direction.

The ring-shaped rotor magnet 12 is fixed to a portion inside the cylindrical part 11 (axis center side) facing the stator core 3 in the radial direction. The rotor magnet 12 is a permanent magnet magnetized in a state in which polarities are alternately inverted in a circumferential direction such as SNSN . . . . The inner circumference of the rotor magnet 12 faces the outer circumference of the stator core 3 (outer circumferential surface of the pole tooth) at a certain distance therefrom.

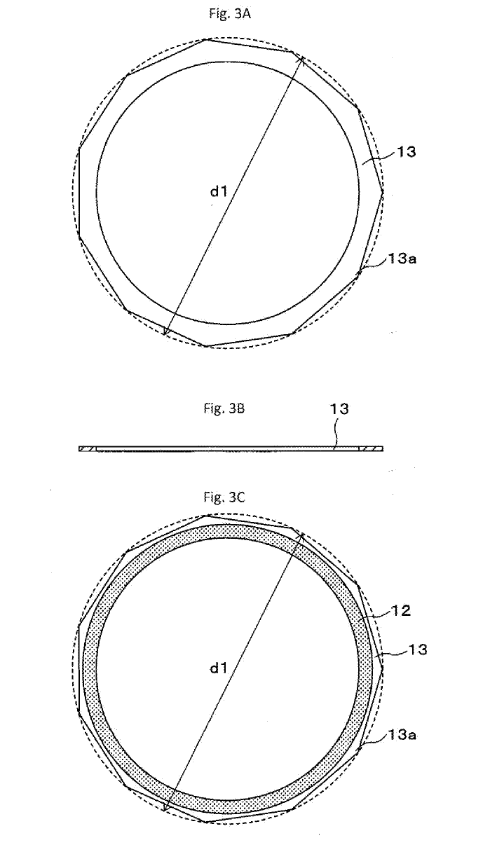

A magnetic attractive plate 13 is disposed at a part of the bottom surface of the base plate 2 facing one end face (bottom end face in the figure) of the rotor magnet 12 in the axial direction. The magnetic attractive plate 13 has a ring shape and is fixed by being disposed in a ring-shaped groove 14 provided in the base plate 2. FIGS. 3A and 3B show top view and a lateral cross-sectional view of the magnetic attractive plate 13. FIG. 3C shows a top view illustrating a positional relationship between the magnetic attractive plate 13 and the rotor magnet 12 viewed from the axial direction.

The ring-shaped magnetic attractive plate 13 has a circular inner circumference and has a regular hendecagonal outer circumference including 11 linear parts and 11 corner parts 13a continuously connecting their respective linear parts. Therefore, the 11 corner parts 13a are provided at equiangular intervals in the circumferential direction. The magnetic attractive plate 13 is formed by punching a tabular magnetic material (magnetic steel sheet in this example) and then deburring it. Note that in the mode shown in FIG. 3, the tip of each corner part connecting two straight lines is pointed, but the tip of each corner part may have a round shape.

The base plate 2 is provided with the ring-shaped groove 14. The base 2 is provided with a ring-shaped protrusion 2c for forming the groove 14. The groove 14 has a circular shape when seen from the axial direction and includes an inner circumferential wall 14a outside in the diameter direction which is an example of a ring-shaped wall surface and an inner circumferential wall 14b inside in the radial direction. The ring-shaped magnetic attractive plate 13 is fitted in the groove 14 and fixed by an adhesive. When the magnetic attractive plate 13 is fitted in the groove 14, all the 11 tips of the corner parts 13a contact the inner circumferential wall 14a of the outside of the groove 14. Note that in FIGS. 1A and 1B, the shape and dimension of the magnetic attractive plate 13 are determined so that the portion where the projected area of the rotor magnet 12 overlaps the surface of the magnetic attractive plate 13 becomes ring-shaped when seen from the axial direction. That is, as shown in FIG. 3C, the whole polygonal outer circumference of the magnetic attractive plate 13 is located outside the outer diameter of the rotor magnet 12 in the radial direction when viewed from the axial direction in FIGS. 1A and 1B. The circular inner circumference of the magnetic attractive plate 13 has the same radius as the inner diameter of the rotor magnet 12. However, since the inner circumference of the magnetic attractive plate 13 is circular, the inner diameter of the rotor magnet 12 may be located either outside or inside with respect to the circular inner circumference of the magnetic attractive plate 13. This is because the portion where the projected area of the rotor magnet 12 overlaps the surface of the magnetic attractive plate 13 becomes ring-shaped in either case. Thus, the area of the rotor magnet 12 projected onto the plane of the magnetic attractive plate 13 becomes constant over the entire circumference irrespective of the angular position, and therefore an attracting force between the magnetic attractive plate 13 and the rotor magnet 12 does not fluctuate according to the angular position, and thereby providing a magnetic attracting force which is stable over the entire circumference.

Dimensions of the respective portions are set so as to fit the magnet attractive plate 13 into the groove 14 firmly by interference fit or transition fit. That is, the outer diameter D1 of the groove 14 is adjusted so that the magnetic attractive plate 13 is press-fitted into the groove 14 in states of interference fit or transition fit with respect to the maximum outer diameter dl of the magnetic attractive plate 13 (corresponding to the diameter of a circle in which the polygonal magnetic attractive plate is inscribed). More specifically, the outer diameter D1 of the groove 14 is adjusted to the order of fitting dimensions in which the components are not moved by a slight vibration and the components can be assembled manually. In this example, the magnetic attractive plate 13 can be press-fitted into the groove 14 in states of interference fit or transition fit by setting dimensions so that the dimensional difference of dl relative to D1 becomes approximately −20 μm to +100 μm, that is, the dimensions are set in states of interference fit or transition fit so that an interference becomes approximately −10 μm to +50 μm. When transition fit is used, the dimensions can be set so as to allow the components to be disassembled before bonding. According to this structure, when the magnetic attractive plate 13 is fitted into the groove 14, the corner parts 13a are held in contact with the inner circumferential wall 14a of the outside of the groove 14 and the magnetic attractive plate 13 is held in engagement with the groove 14. Gaps 16 are formed between the inner circumferential wall 14a of the outside of the groove 14 and an outer circumferential surface of the magnetic attractive plate 13 in parts other than contacting parts at the corner parts 13a.

The gaps 16 are filled with an adhesive and the magnetic attractive plate 13 is fixed inside the groove 14 via the adhesive. That is, in the above-described example, the magnetic attractive plate 13 is fixed to the groove 14 by press fitting and by an adhesive force of the adhesive. Note that while a structure in which the magnetic attractive plate 13 is fixed to the groove 14 by only action of press fitting is possible, a structure using a combination of interference fit or transition fit and an adhesive is preferable from the standpoint of productivity and reliability.

As such an example, the magnetic attractive plate 13 is formed by punching a magnetic steel sheet, and when it is assumed that the inner diameter is 17 mm, the maximum outer diameter dl is 19 mm, the thickness is 0.35 mm, the outer diameter D1 of the groove 14 can be set so that the interference becomes on the order of 20 μm to 40 μm. According to this structure, the corner part 13a of the relatively hard magnetic attractive plate 13 made of a magnetic steel sheet is slightly bitten into the inner circumferential wall 14a of the outside of the groove 14 of the relatively soft base plate 2 made of aluminum alloy and then the magnetic attractive plate 13 is fixed in the state in which the magnetic attractive plate 13 is tightly fitted (press-fitted) into the groove 14.

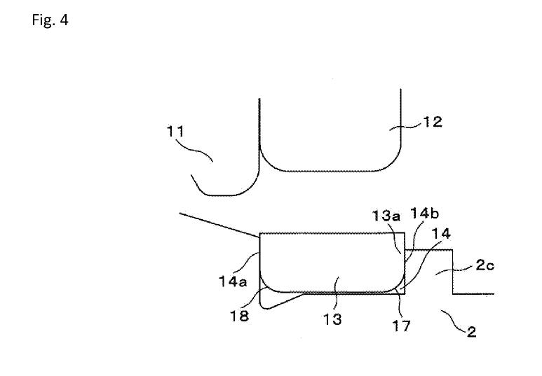

As shown in FIG. 4, roundish roll-over portions 17 and 18 formed during punching of the magnetic attractive plate 13 are provided at the edges of the corner parts 13a on the base plate 2 side. By providing the roll-over portions 17 and 18 on the same side in the axial direction and fitting the magnetic attractive plate 13 from the roll-over portion 17 and 18 sides into the groove 14, it is possible to easily and smoothly perform a fitting operation and prevent deformation of the corner parts 13a during the fitting operation. It is also possible to prevent the engagement part from shaving the material and thereby prevent generation of contaminants.

The number of protruding parts 13a is preferably a prime number of 5 or greater. This is for the following reason. First, according to the principle of a brushless motor, the number of magnetic poles of the rotor magnet is an even number. Also, the number of pole teeth of the stator is a multiple of 2 (2, 4, 6, 8, . . . ) in the case of a single-phase motor or a multiple of 3 (3, 6, 9, 12, . . . ) in the case of a three-phase motor. If the number of corner parts 13a is assumed to be a multiple of 2, a resonance with the rotor magnet may occur. Furthermore, in the case where the number of corner parts 13a is assumed to be a multiple of 3, if the number of magnetic poles of the rotor magnet or the number of stator pole teeth is a multiple of 3, a resonance may occur. In order to avoid this problem, the number of corner parts 13a is preferably a prime number of 5 or greater. However, in the case of a single-phase motor and when the number of stator pole teeth is 4 or 8, the problem with resonance can be avoided by setting the number of corner parts 13a to 9.

Therefore, the number of corner parts 13a is preferably selected from 7, 9 (when the number of stator pole teeth of a single-phase motor is 4 or 8), 11, 13 or 17. It is possible to keep balance of the shape and balance of stability of the fixing structure by “interference fit” within this range. That is, although a magnetic attracting force is also generated between the corner parts 13a and the rotor magnet 12, the corner parts 13a discretely exist in the circumferential direction, and under the influence of switching between poles, the magnitude of the magnetic attracting force periodically fluctuates during rotation. The influence of the periodically fluctuating force is not large, but the influence cannot be ignored when the number of corner parts 13a is small, which causes vibration. However, when the number of corner parts 13a is 7 or greater, the above-described periodic fluctuation is averaged and the influence thereof becomes smaller. When the number of corner parts 13a exceeds 17, the condition of “interference fit” becomes subtle and productivity and stability of the fixed state deteriorate. For this reason, the number of corner parts 13a is preferably selected from the list of 7, 9 (case of a single-phase motor), 11, 13 and 17.

### (Operation)

By passing a drive current through the coil winding 4 and switching between the polarities, the magnetic attracting force and a magnetic repulsive force generated between the magnetic pole of the rotor magnet 12 and the pole teeth of the stator core 3 are switched round, which causes the rotor 20 to rotate with respect to the base plate 2. In this case, the rotor magnet 12 is attracted to the magnetic attractive plate 13 in the axial direction, preventing the fluctuation of the hub 9 with respect to the base plate 2 in the axial direction and the contact between the stopper part (flange part 7a) of the shaft 7 and the bearing part 5 due to a change in the orientation of the hard disk drive.

### (Assembly Step)

Hereinafter, an example of operation of fixing the magnetic attractive plate 13 into the groove 14 will be described. A thermosetting type adhesive is applied to the inside of the groove 14 and then the magnetic attractive plate 13 is caused to engage with the groove 14. In this case, the adhesive is pushed down and spread on the bottom surface of the groove 14, the end face (bottom end face) of the magnetic attractive plate 13 and the gaps 16 (see FIG. 2). In this state, the magnetic attractive plate 13 is temporarily fixed to the groove 14. In this state, the magnetic attractive plate 13 is engaged with the groove 14 at a degree of tightness at which the magnetic attractive plate 13 does not move in the groove 14, and the magnetic attractive plate 13 is temporarily fixed inside the groove 14 during the hardening process of the adhesive.

Once the magnetic attractive plate 13 is temporarily fixed to the groove 14, the magnetic attractive plate 13 is heated in a drying furnace to harden the adhesive. In this case, since the magnetic attractive plate is temporarily fixed to the groove 14 due to the engagement structure in which the corner part 13a is brought into contact, it is possible to prevent a positional shift of the magnetic attractive plate 13 caused by handling before hardening of the adhesive or contraction during hardening. The gap 16 has such a shape that as it moves away from the engagement part, the width of the gap increases. Since the gap 16 functions as an adhesive sump, the adhesive extruded from the engagement part or the narrow portion in the gap smoothly moves to a broad part, uniformly spreads, thereby providing a strong and stable fixing structure. Note that as for the adhesive, not only one that displays an adhesive force by heating but also an ultraviolet curable adhesive or anaerobic adhesive can be used.

In addition, a method of fixing the magnetic attractive plate 13 to the groove 14 according to the following steps may also be adopted. First, the magnetic attractive plate 13 is fitted into the groove 14 and temporarily fixed. Next, an adhesive is injected into the gaps 16 (see FIG. 2) and the adhesive is then caused to harden. In this case, since the magnetic attractive plate is temporarily fixed to the groove 14 due to the engagement structure in which the corner parts 13a are brought into contact, it is possible to prevent a positional shift of the magnetic attractive plate 13 following the hardening of the adhesive. Furthermore, since the gap 16 functions as the adhesive sump, the adhesive spreads uniformly, thereby providing a strong and stable fixing structure.

### (Advantages)

In the present embodiment, a plurality of corner parts 13a are provided on the outer circumference of the magnetic attractive plate 13, the corner parts 13a are caused to engage with the wall surface of the ring-shaped groove 14 on the base plate 2 side in a “interference fit” condition, and the magnetic attractive plate 13 is further fixed to the groove 14 using an adhesive. According to this structure, the magnetic attractive plate 13 is temporarily fixed in the groove 14 until the adhesive hardens and it is possible to fix the magnetic attractive plate 13 to the base plate 2 with high positional accuracy without using any fixing jig. Furthermore, by setting the number of corner parts 13a to a prime number of 5 or greater, it is possible to prevent the occurrence of undesired resonance.

### (Modification)

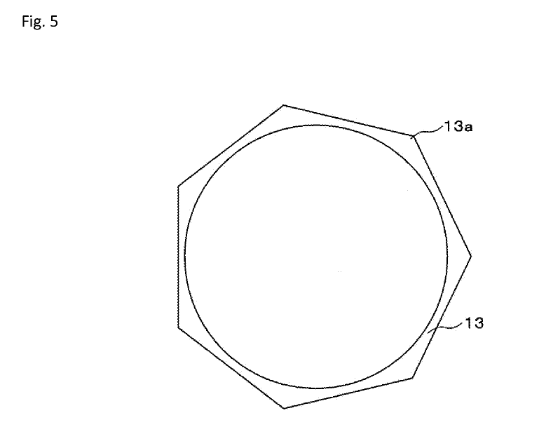

FIG. 5 shows an example of a case where an outside shape of the magnetic attractive plate 13 is a regular heptagon. In this case, the number of corner parts 13a is 7.

### 2. Second Embodiment

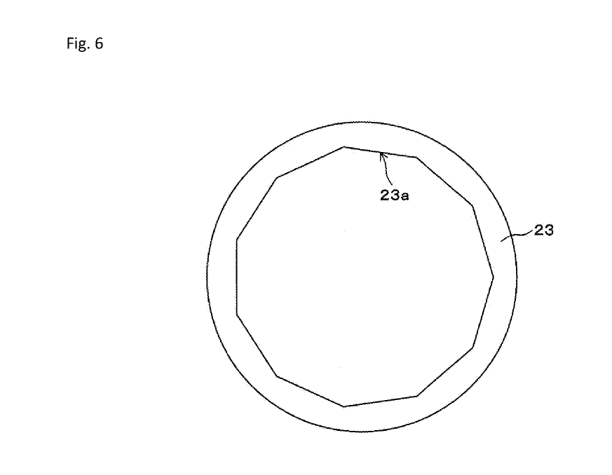

A structure is also possible in which the inside edges of the ring-shaped magnetic attractive plate is formed into a regular polygonal shape so as to fit into the groove of the base plate. FIG. 6 illustrates a magnetic attractive plate 23. The magnetic attractive plate 23 has a circular outer circumference (outside contours) and a polygonal inner circumference (inside contours) (in this case, regular hendecagon) when seen from the axial direction. The limitation associated with the number of angles of inner circumference is the same as that in the case of the first embodiment.

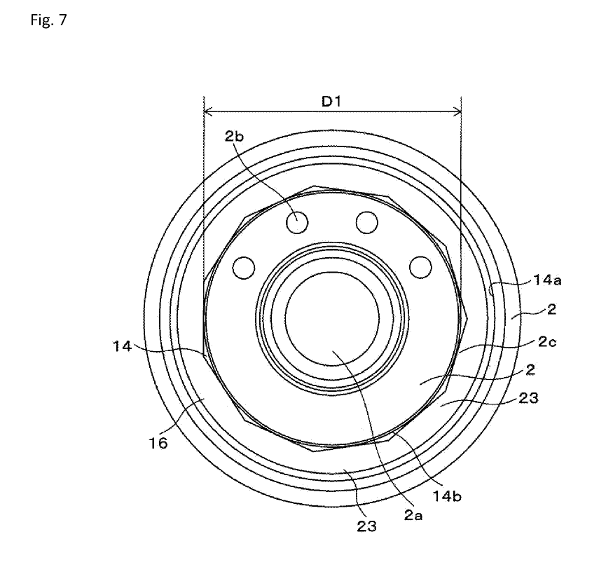

FIG. 7 illustrates a state in which the magnetic attractive plate 23 is fitted into the ring-shaped groove 14 provided in the base plate 2. In this case, the diameter of the inscribed circle of the inside contour of the magnetic attractive plate 23 is set to a dimension slightly smaller than the inner diameter D1 of the groove 14 (value smaller by approximately 5 to 100 μm). For this reason, the vicinity of the center of a flat surface 23a has strong contact with the inner circumferential wall 14b (see FIG. 1B) of the inside of the groove 14 and the magnetic attractive plate 23 is press-fitted into the groove 14 as in the case of the magnetic attractive plate 13 in the first embodiment. In this case, the magnetic attractive plate 23 is fixed to the groove 14 using an adhesive, but the magnetic attractive plate 23 is held to the groove 14 while being kept immobile until the adhesive hardens. Note that the setting of a dimensional relationship is adjusted so that the polygonal inner circumference of the magnetic attractive plate 23 is not located outside the inner diameter of the rotor magnet 12. The circular outer circumference of the magnetic attractive plate 23 may be outside, inside or of the same radius as or with respect to the outer diameter of the rotor magnet 12. Thus, the area of the rotor magnet 12 projected onto the surface of the magnetic attractive plate 23 is ring-shaped and becomes constant over the whole circumference. As a result, the attracting force between the magnetic attractive plate 23 and the rotor magnet 12 does not fluctuate according to the angular position, thereby providing a magnetic attracting force which is stable over the whole circumference.

### 3. Third Embodiment

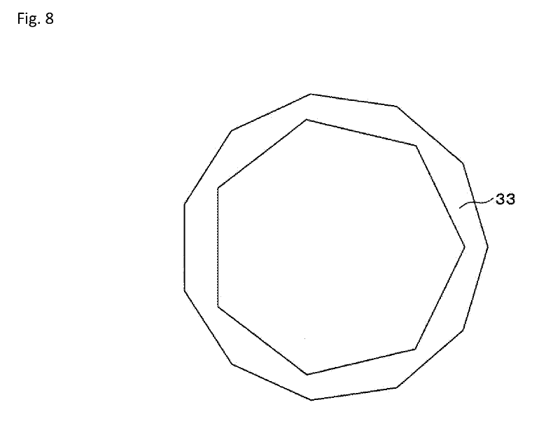

A structure is also possible in which the ring-shaped magnetic attractive plate engages with the base plate on both the inner circumference and the outer circumference thereof. Hereinafter, an example of this case will be described. FIG. 8 illustrates a magnetic attractive plate 33. The magnetic attractive plate 33 is an example of a case where the outer circumference and the inner circumference have polygonal shapes. In this example, the outer circumference is assumed to be a regular hendecagon and the inner circumference is assumed to be a regular heptagon. In this case, the corner parts of the outer circumference of the magnetic attractive plate 33 strongly contact the inner circumferential wall 14a of the groove 14 of the base plate 2 (see FIG. 1B) and the linear parts of the inner circumference strongly contact the inner circumferential wall 14b of the groove 14. In this structure, the maximum value of the outer diameter of the magnetic attractive plate 33 is set to be slightly larger than the outer diameter of the groove 14 and the minimum value of the inner diameter of the magnetic attractive plate 33 is set to be slightly smaller than the inner diameter of the groove 14.

Note that the number of corner parts may be the same for the outer circumference contour and for the inner circumference contour. The number of corner parts of the outer circumference contour may be relatively smaller than the number of corner parts of the inner circumference contour. The aspect that an interference fit or transition fit structure is adopted and limitation associated with the number of corner parts are the same as those in the cases of the first and second embodiments. When viewed from the axial direction, an adjustment is made so that the outer circumference of the magnetic attractive plate 33 is located outside the outer diameter of the rotor magnet 12 in the radial direction and the inner circumference of the magnetic attractive plate 33 is located inside the inner diameter of the rotor magnet 12 in the radial direction. A magnetic attracting force which is stable over the entire circumference is obtained in this way.

### 4. Fourth Embodiment

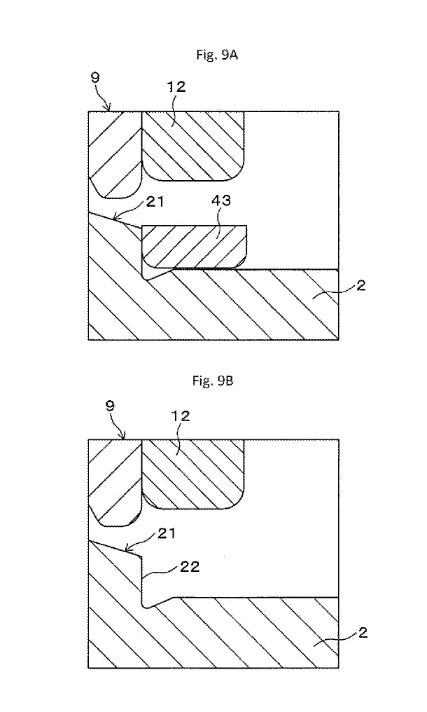

A structure is also possible in which the base plate 2 is provided without groove 14. FIG. 9A illustrates a state in which a ring-shaped magnetic attractive plate 43 is attached to the base plate 2. FIG. 9B illustrates a state in which the magnetic attractive plate 43 is removed from FIG. 9A. In this example, the magnetic attractive plate 43 is the same as the magnetic attractive plate 13 in FIGS. 1A and 1B. In this example, the base plate 2 is provided with a ring-shaped stepped part 21 and a ring-shaped wall surface 22 is formed using a part of the stepped part 21 on the inner circumference side. The ring-shaped wall surface 22 has a circular shape centered on the rotation center of the shaft 7 when viewed from the axial direction. The outer circumference of the magnetic attractive plate 43 is caused to engage with the ring-shaped wall surface 22. A polygonal shape whose outer circumference is formed of a plurality of linear parts and a plurality of corner parts such as the magnetic attractive plate 13 in FIG. 3A and the magnetic attractive plate 33 in FIG. 8 is used for the magnetic attractive plate 43. By setting a slightly large maximum outer diameter of the magnetic attractive plate 43 with respect to the diameter of the ring-shaped wall surface 22, a structure is obtained in which the outer circumference of the magnetic attractive plate 43 is engaged with the ring-shaped wall surface 22 in an interference fit state. Note that a structure is also possible in which the outer circumference of the magnetic attractive plate 43 is engaged with the ring-shaped wall surface 22 in a transition fit state.

### 5. Fifth Embodiment

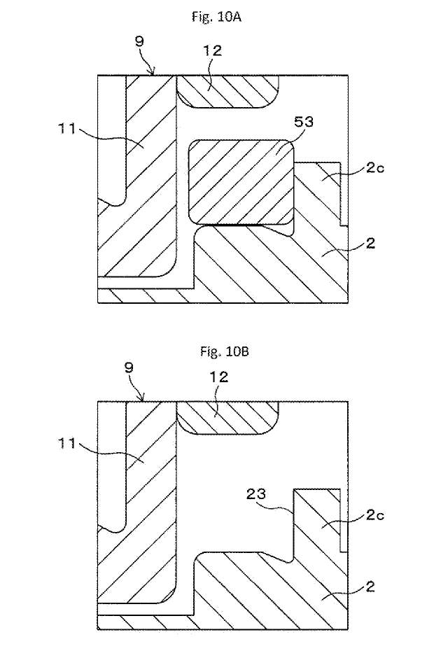

FIGS. 10A and 10B illustrate another example of the structure in which the base plate is provided without ring-shaped groove. FIG. 10A illustrates a state in which a ring-shaped magnetic attractive plate 53 is attached to the base plate 2 and FIG. 10B illustrates a state in which the magnetic attractive plate 53 is removed from FIG. 10A. In this example, a ring-shaped wall surface 23 which is a wall surface of the outside of the ring-shaped protrusion 2c shown in FIGS. 1A and 1B in the diameter direction in the base plate 2 is used. The ring-shaped wall surface 23 has a circular shape centered on a rotary center of the shaft 7 when viewed from the axial direction. An inner circumference of the magnetic attractive plate 44 is engaged with the ring-shaped wall surface 23. A polygonal shape whose inner circumference is formed of a plurality of linear parts and a plurality of corner parts such as the magnetic attractive plate 23 in FIG. 6 and the magnetic attractive plate 33 in FIG. 8 is used for the magnetic attractive plate 53. By setting, for example, a slightly small minimum inner diameter of the magnetic attractive plate 53 with respect to the diameter of the ring-shaped wall surface 23, a structure is obtained in which the inner circumference of the magnetic attractive plate 53 is engaged with the ring-shaped wall surface 23 in an interference fit state. Note that a structure is also possible in which the inner circumference of the magnetic attractive plate 53 is engaged with the ring-shaped wall surface 23 in a transition fit state.

### 6. Others

Aspects of the present disclosure are not limited to the aforementioned individual embodiments, but include various modifications that would be thought of by those skilled in the art, and the effects of the present disclosure is not limited to the aforementioned contents. That is, various additions, modifications and partial deletions can be made without departing from the conceptual thought and spirit of the present disclosure deriving from the contents defined in the scope of appended claims and equivalents thereof. The spindle motor of the present disclosure is not limited to ones for a hard disk drive but is also applicable to another drive apparatus such as magnetic disk, optical disk, magneto-optical disk or the like.

What is claimed is:

1. A spindle motor comprising:
a base plate;
a stator core fixed to the base plate;
a rotor member rotatable with respect to the base plate;
a rotor magnet facing the stator core in a radial direction and fixed to the rotor member; and
a ring-shaped magnetic attractive plate attached to a bottom surface of the base plate in a manner to face the rotor magnet in an axial direction and configured to generate a magnetic attracting force between the rotor magnet and the magnetic attractive plate,
wherein a ring-shaped wall surface is provided on the bottom surface of the base plate,
at least one of an outer circumference and an inner circumference of the ring-shaped magnetic attractive plate has a polygonal shape formed of a plurality of linear parts and a plurality of corner parts, and
the ring-shaped magnetic attractive plate is fixed to the base plate with an adhesive in a condition that at least one of the outer circumference and the inner circumference having the polygonal shape is in contact with the ring-shaped wall surface.

2. The spindle motor according to claim 1, wherein the number of the corner parts in the polygonal shape of the magnetic attractive plate is a prime number.

3. The spindle motor according to claim 2, wherein the prime number is any one of 7, 11, 13, 17 and 19.

4. The spindle motor according to claim 1, wherein a portion of the magnetic attractive plate where at least one of the outer circumference and the inner circumference having the polygonal shape is in contact with the ring-shaped wall surface is fitted by an interference fit or transition fit.

5. The spindle motor according to claim 1, wherein the outer circumference or the inner circumference of the magnetic attractive plate is circular.

6. The spindle motor according to claim 1, wherein the same number of corner parts are formed on the inner circumference and the outer circumference of the magnetic attractive plate.

7. The spindle motor according to claim 1, wherein the outer circumference and the inner circumference of the magnetic attractive plate have roll-over portions on the same side in the axial direction and the magnetic attractive plate is fixed with the side with the roll-over portions facing the bottom surface of the base plate.

8. The spindle motor according to claim 1, wherein the outer circumference of the magnetic attractive plate having the polygonal shape when viewed from the axial direction is located outside the outer diameter of the rotor magnet in the radial direction.

9. The spindle motor according to claim 1, wherein the inner circumference of the magnetic attractive plate having the polygonal shape when viewed from the axial direction is located inside the inner diameter of the rotor magnet in the radial direction.
